(19) United States
(12) Patent Application Publication
(10) Pub. No.: US 2015/0317766 A1
(43) Pub. Date: Nov. 5, 2015

(54) IMAGE DISPLAY SYSTEM, IMAGE DISPLAY METHOD, AND STORAGE MEDIUM

(71) Applicant: CANON KABUSHIKI KAISHA, Tokyo (JP)

(72) Inventor: Yoshihiro Naganawa, Yokohama-shi (JP)

(21) Appl. No.: 14/698,651

(22) Filed: Apr. 28, 2015

(30) Foreign Application Priority Data
Apr. 30, 2014 (JP) 2014-093899

(51) Int. Cl. G06T 3/40

(52) U.S. Cl. CPC G06T 3/40; G06T 2210/41

(57) ABSTRACT

An image display apparatus includes a display unit configured to display, when processing information representing an image process to be performed on an image to be displayed is associated with the image to be displayed, the image which has been subjected to the image process corresponding to the processing information after the image which has not been subjected to the image process is displayed.

### BACKGROUND OF THE INVENTION

1. Field of the Invention

The disclosed technique relates to image display and, more particularly, to an image display system, an image display method, and a storage medium.

2. Description of the Related Art

In general, as a high resolution of a processed image is demanded, a method for managing a set of an original image of a high resolution and a thumbnail image of a low resolution generated from the original image has been widely used. Accordingly, thumbnail images may be easily displayed as a list, and when details are to be checked, an original image may be referred to using the thumbnail image.

Therefore, visibility as a list is improved for a user and detailed information may be checked where appropriate, and therefore, access efficiency is improved. Furthermore, depending on content of an operation, the operation may be performed using the thumbnail image without using the original image, and accordingly, usability is enhanced.

On the other hand, since the number of displayed information and the number of available operations in the displayed list are increased, management and operations are complicated. Accordingly, it is difficult to recognize a state and content of a certain image in a large number of images. To address this problem, Japanese Patent Laid-Open No. 2008-192044 discloses a technique of displaying thumbnails of images or documents for each item in a time-series manner. By this, the user may determine whether original data of a thumbnail has been viewed so as not to check an original image again in vain.

However, in the technique disclosed in Japanese Patent Laid-Open No. 2008-192044, in a case where a portion of a thumbnail is important, the important portion is recalled or determined after the thumbnail is displayed. Thereafter, an operation for displaying the important portion is performed. Furthermore, if the thumbnail is associated with a plurality of images or a plurality of important portions are included in the thumbnail, the determination and the operation are to be performed a plurality of times. Moreover, although a method for displaying the important portion from the beginning may be considered, in this case, the user may not recognize a position of the displayed portion in an entire image.

### SUMMARY OF THE INVENTION

The disclosed technique is made in view of the above problems and provides display of a target image in an appropriate state without a complicated user's operation.

Accordingly, an image display system includes a display unit configured to display, when processing information representing an image process to be performed on an image to be displayed is associated with the image to be displayed, the image which has been subjected to the image process corresponding to the processing information after the image which has not been subjected to the image process is displayed.

Further features of the present disclosure will become apparent from the following description of exemplary embodiments with reference to the attached drawings.

### BRIEF DESCRIPTION OF THE DRAWINGS

FIG. 1 is a diagram illustrating an image display system.

FIG. 2 is a diagram illustrating a hardware configuration of a client apparatus.

FIGS. 3A and 3B are a flowchart illustrating an image display process according to a first embodiment.

FIGS. 4A to 4C are diagrams illustrating display of thumbnail images.

FIGS. 5A to 5C are diagrams illustrating a process from step S303 to step S308.

FIG. 6 is a diagram illustrating a process from step S311 to step S313.

FIGS. 7A to 7C are a flowchart illustrating an image display process according to a second embodiment.

FIG. 8 is a diagram illustrating an image group.

FIGS. 9A and 9B are diagrams illustrating display of a sliced image.

FIGS. 10A and 10B are diagrams illustrating display of a sliced image.

FIG. 11 is a diagram illustrating a first modification of the second embodiment.

FIG. 12 is a diagram illustrating a second modification of the second embodiment.

### DESCRIPTION OF THE EMBODIMENTS

Embodiments of the present disclosure will be described hereinafter with reference to the accompanying drawings.

### First Embodiment

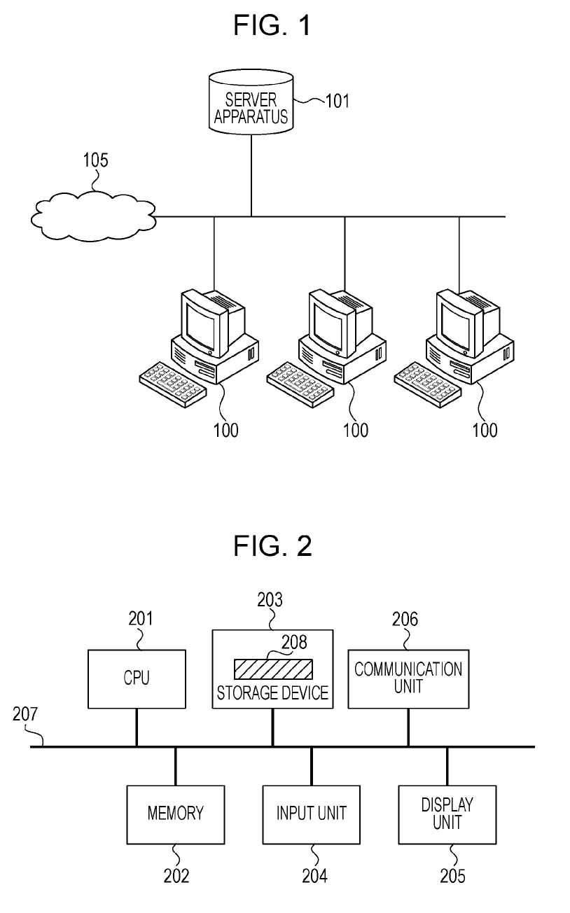

FIG. 1 is a diagram illustrating an image display system according to a first embodiment. The image display system includes a plurality of client apparatuses 100 and a server apparatus 101 which are connected to a network 105. Each of the client apparatuses 100 is an example of an image display apparatus. Hereinafter, the client apparatuses 100 are collectively referred to as a client apparatus 100 where appropriate. The server apparatus 101 stores and manages an image to be displayed and supplies information on the image and the like to the client apparatus 100 in response to a request supplied from the client apparatus 100. In this embodiment, a case where an image captured by X-ray photographing is displayed is described as an example. However, images to be displayed by the image display system are not limited to images captured by the X-ray photographing.

The client apparatus 100 obtains information on an image or the like from the server apparatus 101. The client apparatus 100 displays a thumbnail image associated with the image in a display unit described below. The client apparatus 100 displays the image associated with the thumbnail image when a user selects the thumbnail image. In this embodiment, it is assumed that a single image is associated with a single thumbnail image.

Although the server apparatus 101 stores and manages images in this embodiment, the client apparatus 100 may store and manage images as another example. In this case, the server apparatus 101 is omitted.

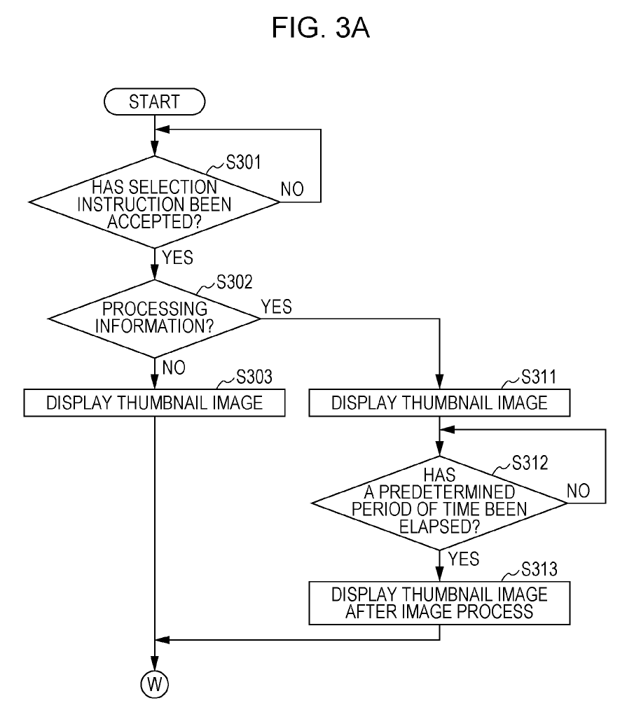

FIG. 2 is a diagram illustrating a hardware configuration of the client apparatus 100. The client apparatus 100 includes a central processing unit (CPU) 201, a memory 202, a storage device 203, an input unit 204, a display unit 205, and a communication unit 206. The units are connected to one another through a bus 207. The CPU 201 executes various functions described below by executing a program 208 stored in the storage device 203. The memory 202 temporarily stores programs and data read by the CPU 201 from the storage device 203. Furthermore, the memory 202 is utilized when the CPU 201 executes the various programs. As used herein, the term “unit” generally refers to any combination of software, firmware, hardware, or other component, such as circuitry, that is used to effectuate a purpose.

The storage device 203 stores an operating system (OS), the various programs, a control program, data, and so on. Examples of the data include images. Examples of the programs include programs for recording operations performed at times when the images are viewed. The storage device 203 is a mass-storage apparatus, such as a solid state drive (SSD) or a hard disk drive (HDD). In this embodiment, the storage device 203 stores captured images to be displayed which are associated with thumbnail images. The CPU 201 displays the plurality of thumbnail images stored in the storage device 203 in the display unit 205 as a list.

The input unit 204 mainly receives a user's input. The input unit 204 receives input of an instruction for displaying an image, an operation instruction, and the like. The display unit 205 displays various types of information. The display unit 205 displays images, information received by the input unit 204, results of execution of programs performed by the CPU 201, and the like. The communication unit 206 is connected to the network 105 so as to communicate with other apparatuses. The communication unit 206 receives an image from the server apparatus 101 and transmits a request for an image to the server apparatus 101, for example. When images are stored in the client apparatus 100, the communication unit 206 may not be included in the client apparatus 100. Furthermore, the input unit 204 and the display unit 205 may be integrally disposed as a touch panel.

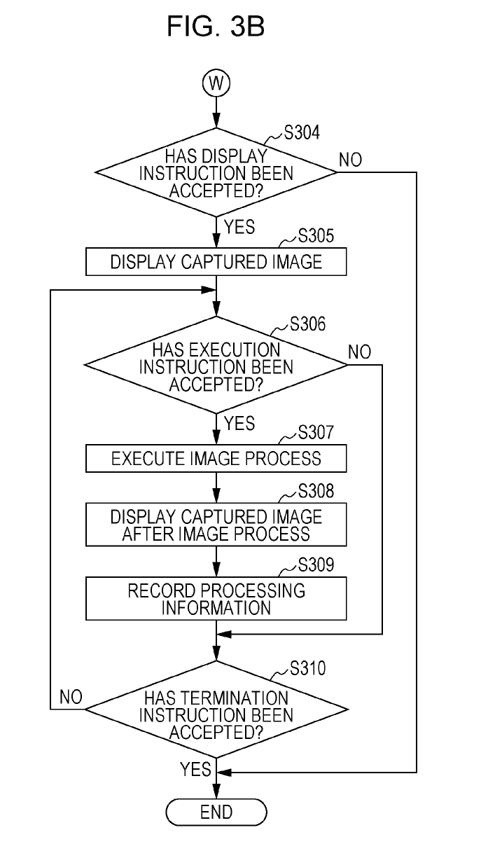

FIGS. 3A and 3B are a flowchart illustrating an image display process performed by the client apparatus 100.

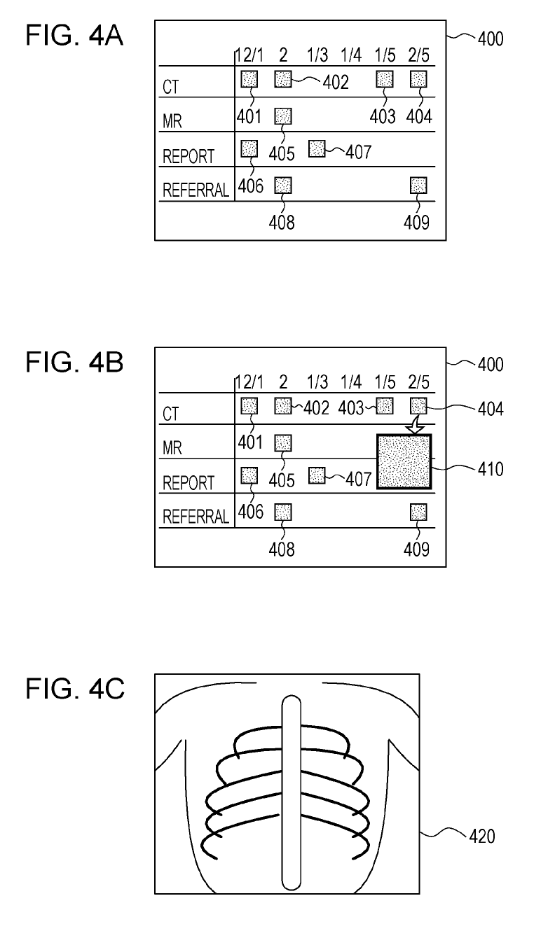

The client apparatus 100 executes the image display process in accordance with the program 208. It is assumed that the display unit 205 displays images as a list before the image display process is performed. FIG. 4A is a diagram illustrating an image list. A plurality of thumbnail images 401 to 409 are displayed as an image list 400. Note that the thumbnail images are examples of reduced images.

In step S301, the CPU 201 of the client apparatus 100 waits until an instruction for selecting a thumbnail image to be displayed from among the plurality of thumbnail images displayed as a list in the image list 400 is received. When a user's operation, such as an operation of moving a mouse cursor to a thumbnail image or an operation of clicking on the thumbnail image is performed to select the thumbnail image, the CPU 201 accepts the selection instruction through the input unit 204. Furthermore, as another example, the CPU 201 may receive a selection instruction through the input unit 204 when a thumbnail image is selected by a user's operation, such as tapping or a touch for a predetermined period of time on the touch panel.

When the CPU 201 receives the selection instruction (Yes in step S301), the process proceeds to step S302. In step S302, the CPU 201 determines whether processing information is associated with a captured image corresponding to the thumbnail image of the selection instruction in the storage device 203. The processing information relates to an image process to be performed on the captured image. Specifically, the processing information represents content of the image process to be performed on the captured image. The processing information is recorded in the storage device 203 in a process in step S309 described below, and the process will be described in detail hereinafter. When the processing information is associated with the captured image (Yes in step S302), the CPU 201 proceeds to step S311. When the processing information is not associated with the captured image (No in step S302), the CPU 201 proceeds to step S303.

In step S303, the CPU 201 enlarges the thumbnail image corresponding to the selection instruction so as to display the thumbnail image by pop-up. For example, in a case where the thumbnail image 404 illustrated in FIG. 4A is selected, the CPU 201 displays an enlarged thumbnail image 410 corresponding to the thumbnail image 404 as illustrated in FIG. 4B. The enlarged thumbnail image 410 represents an image in a display range corresponding to the thumbnail image 404 displayed larger in size when compared with the thumbnail image 404.

Subsequently, in step S304, the CPU 201 determines whether a display instruction has been received.

The display instruction is information for instructing display of a captured image corresponding to a thumbnail image.

The CPU 201 receives the display instruction when a user's operation, such as clicking on the enlarged thumbnail image 410 illustrated in FIG. 4B, is performed, for example. Furthermore, the CPU 201 receives the display instruction when a user's operation, such as tapping on the enlarged thumbnail image 410, is performed in a case of the touch panel.

Moreover, the CPU 201 receives the display instruction for displaying a captured image when a user's operation different from the user's operation for the selection instruction for selecting a thumbnail image, such as double click on one of the thumbnail images 401 to 409 of a normal size displayed as the list as illustrated in FIG. 4A, is performed.

When the CPU 201 receives the display instruction (Yes in step S304), the process proceeds to step S305. When the CPU 201 does not receive the display instruction (No in step S304), the image display process is terminated.

Subsequently, in step S305, the CPU 201 displays a captured image corresponding to the display instruction. FIG. 4C is a diagram illustrating display of a captured image 420. Thereafter, in step S306, the CPU 201 determines whether an instruction for executing an image process on the captured image corresponding to the thumbnail image displayed in the display unit 205 has been received through the input unit 204. Here, the image process is a process of displaying a portion of the captured image in an enlargement manner, that is, a process of generating an enlarged image of a portion of the captured image. A type of the image process is not limited to the embodiment, and any image process may be performed as long as the process changes content of display depending on a captured image. Examples of the image process include a process of changing display parameters relating to luminance, brightness, depth, and the like.

When the CPU 201 receives the execution instruction (Yes in step S306), the process proceeds step S307. When the CPU 201 does not receive the execution instruction (No in step S306), the process proceeds step S310. Here, the process in step S306 represents an example of a reception process of receiving an execution instruction.

In step S307, the CPU 201 performs the image process on the captured image being displayed in response to the execution instruction. Next, in step S308, the CPU 201 displays the captured image which has been subjected to the image process, that is, the captured image after the image process, in the display unit 205. In step S309, the CPU 201 stores processing information representing content of the image process executed in step S307 which is associated with the captured image to be displayed and the corresponding thumbnail image in the storage device 203. The processing information is required when the image process executed in step S307 is performed again. In this way, the CPU 201 records the content of the image process actually executed as the processing information representing the content of the image process to be performed on an image. Here, the process in step S309 represents an example of a processing information management process.

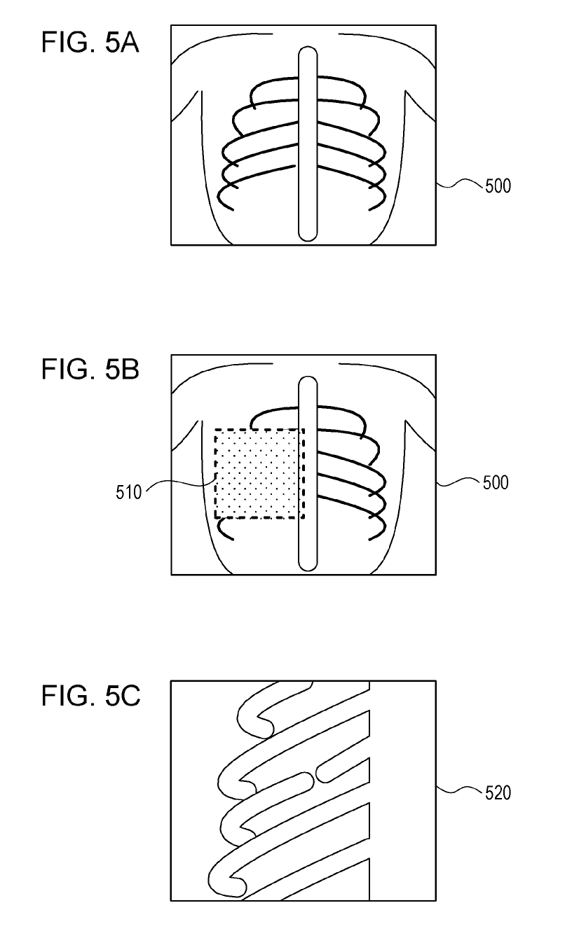

FIGS. 5A to 5C are diagrams illustrating the process from step S305 to step S308. It is assumed that, in a state in which an x-ray captured image 500 of an upper body is displayed (step S305) as illustrated in FIG. 5A, a doctor selects a partial region 510 of a rib as a target region as illustrated in FIG. 5B. In this case, the CPU 201 receives an instruction for executing an image process for displaying the partial region 510 in an enlargement manner (step S306). The CPU 201 performs an image process of generating an enlarged image 520 corresponding to the partial region 510 (step S307), and displays the generated enlarged image 520 in the display unit 205 (S308) as illustrated in FIG. 5C. According to the enlarged image 520, a rib bone is broken.

In a case where the image process of displaying the image in an enlargement manner described with reference to FIGS. 5A to 5C is performed, processing information includes information on the enlargement process and information on a position and a size of the region to be enlarged. As another example, the processing information may include information on the enlargement process and information on a center position and an enlargement factor of the region to be enlarged.

The image which has been subjected to the image process may include the target region (fracture portion in the example of FIG. 5C) to which the user pays attention. Specifically, the image obtained after the image process is displayed in a state in which the user may easily recognize the target region. Therefore, in this embodiment, the client apparatus 100 records the processing information associated with the image process of enlarging the target region so that the target region is to be displayed again.

As another example, the client apparatus 100 may record the processing information representing content of the image process in the storage device 203 when the image is simply displayed and the image is further displayed for a predetermined period of time. By this, the client apparatus 100 may determine only a region displayed for a predetermined period of time as the target region and record corresponding processing information.

Referring back to FIG. 3B, after the processing information is recorded in step S309, the CPU 201 terminates the image display process when receiving a termination instruction from the user in step S310 (Yes in step S310). When the CPU 201 does not receive the termination instruction from the user (No in step S310), the process returns to step S306.

On the other hand, in step S311, the CPU 201 displays a thumbnail image corresponding to the enlargement display instruction in the display unit 205. Thereafter, in step S312, the CPU 201 displays an enlarged thumbnail image and waits until a predetermined period of time is elapsed. The CPU 201 proceeds to step S313 after the predetermined period of time has been elapsed (Yes in step S312). In step S313, the CPU 201 performs the image process on the enlarged thumbnail image in accordance with the processing information associated with a captured image corresponding to the enlarged thumbnail image (image process). Then the CPU 201 displays the enlarged thumbnail image obtained after the image process in the display unit 205 instead of the enlarged thumbnail image, and thereafter, the process proceeds to step S304.

In this way, in step S313, the CPU 201 displays the enlarged thumbnail image obtained after the image process performed in accordance with the processing information. On the other hand, in step S303 and step S311, the CPU 201 displays the enlarged thumbnail image which has not been subjected to the image process. Here, the process from step S311 to step S313 is an example of a display process of displaying an image obtained after image process corresponding to processing information after an image which has not been subjected to the image process is displayed.

Note that, as another example, the image display system may perform an image process on a captured image corresponding to a thumbnail image in accordance with processing information and generate a thumbnail image from the captured image which has been subjected to the image process.

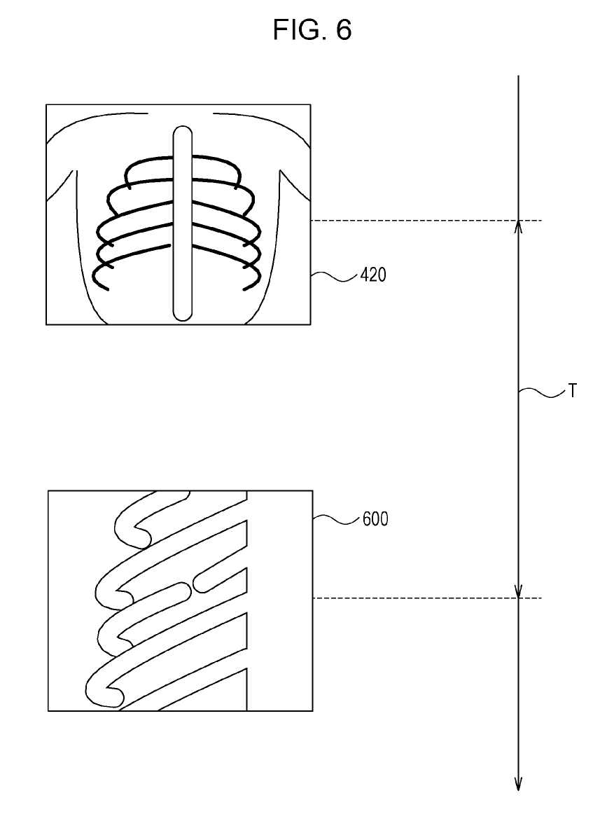

FIG. 6 is a diagram illustrating the process from step S311 to step S313. The CPU 201 first displays the enlarged thumbnail image 420 corresponding to the X-ray image of the upper body as an image which has not been subjected to the image process. When a predetermined period of time T is elapsed after the thumbnail image 420 is displayed, the CPU 201 automatically switches content of the display to an enlarged thumbnail image 600 which has been subjected to the image process. Here, the CPU 201 may display animation such that the enlarged thumbnail image 420 which has not been subjected to the image process is gradually changed to the enlarged thumbnail image 600 which has been subjected to the image process. It is assumed that, in the image process, a partial region of a captured image is extracted and the extracted region is enlarged. In this case, the CPU 201 may display zoom animation such that an enlarged thumbnail image is gradually enlarged until the extracted region is displayed in a region in which the enlarged thumbnail image is displayed.

By this, the client apparatus 100 may display a thumbnail image which is viewed by the user and which is associated with processing information in a state in which the thumbnail image has been subjected to the image process of displaying a target region after the image which has not been subjected to the image process is displayed. Accordingly, the user may visually recognize a desired region in a desired display mode without performing a complicated operation.

Furthermore, the captured image which has not been subjected to the image process is displayed before the image which has been subjected to the image process is displayed since the user may recognize the relationship between the image which has been subjected to the image process and the image which has not been subjected to the image process. As described with reference to FIGS. 5A to 5C and FIG. 6, it is assumed that, in the image process, a partial region of an entire image of an entire upper body or the like is displayed in an enlargement manner. In this case, if only an enlarged image is displayed, it is difficult for the user to recognize the relationship between the enlarged image which has been subjected to the image process and the entire image which has not been subjected to the image process. In the example illustrated in FIG. 6, it is difficult for the user to recognize that a fracture portion in a number of rib bones only from the enlarged thumbnail image 600. On the other hand, when the entire image is displayed first, the user may easily recognize the relationship between the image which has been subjected to the image process and the image which has not been subjected to the image process.

As described above, in the image display system according to the first embodiment, when a target region which is desired by the user is included in an image to be displayed, the target region may be displayed in a state in which the user may easily recognize the target region without performing a complicated operation. Furthermore, in the image display system, after an image which has not been subjected to the image process is displayed, an image which has been subjected to the image process is displayed so that a target region is easily recognized, and consequently, the user may recognize the relationship between the image which has been subjected to the image process and the image which has not been subjected to the image process. Specifically, the image display system displays a target image in an appropriate state without causing the user to perform a complicated operation.

Note that as a first modification of the image display system of the first embodiment, processing information may directly correspond to an image which has been subjected to an image process. In this case, in step S313, the CPU 201 displays the image which has been subjected to the image process stored in a state in which the image is associated with a captured image in the processing information.

Furthermore, as a second modification, in the client apparatus 100, in addition to the determination in step S302 of FIG. 3A, when a determination as to whether an amount of change of an image which has been subjected to an image process from an image which has not been subjected to the image process is large is affirmative, the process may proceed to step S311.

Specifically, in the client apparatus 100, the process may proceed to step S311 when it is determined that processing information exists in step S302 and it is determined that the change amount is equal to or larger than a threshold value, whereas the process may proceed to step S303 when it is determined that the change amount is smaller than the threshold value. Here, the change amount represents an amount of change in scale of a display region or an amount of change of a display position of the display region in the image before and after the image process. It is assumed that the threshold value is stored in the storage device 203 or the like in advance. This is because, when a degree of the change is small, the user may recognize the relationship between the images before and after the image process without displaying the image which has not been subjected to the image process before the image which has been subjected to the image process is displayed.

Furthermore, as a third modification, the CPU 201 displays a captured image which has been subjected to an image process after a captured image which has not been subjected to the image process is displayed. In this case, a timing when the captured image which has not been subjected to the image process is switched to the captured image which has been subjected to the image process is not limited to the embodiment. For example, the CPU 201 may display the captured image which has been subjected to the image process at a timing when a switching instruction is received (reception process) from a user after the captured image which has not been subjected to the image process is displayed.

As a fourth modification, the CPU 201 may specify a target region in accordance with a memorandum or information on modality or the like recorded when a target image is displayed, specify an image process to be performed for displaying the target region, and record processing information.

As a fifth modification, the CPU 201 may not display a thumbnail image corresponding to an enlargement instruction in an enlargement manner in at least one of step S303 and step S311. If the thumbnail image is not displayed in an enlargement manner in step S311, the CPU 201 displays the thumbnail image which has been subjected to the image process in a normal size in a region in which the thumbnail image of a normal size is displayed as a list in step S313.

As a sixth modification, the CPU 201 may display a captured image, instead of a thumbnail image, in an image list 400 which is displayed before an image display process is performed. As described above, types of image to be processed by the image display system are not limited to the embodiment. Furthermore, when the captured image is to be displayed in the image list 400, a captured image corresponding to an enlargement instruction is displayed in step S303 and step S311 and the captured image which has been subjected to the image process is displayed in step S313.

### Second Embodiment

An image display system according to a second embodiment displays not only individual images but also an image group. The image group includes a plurality of still images to be consecutively displayed. The image group includes a plurality of images captured by CT or MRI, for example. Furthermore, the image group may be a moving image having a plurality of frames.

In the second embodiment, a client apparatus 100 obtains not only individual images but also an image group from a server apparatus 101. As for the individual images, the client apparatus 100 associates a single thumbnail image with a single image. As for the image group, the client apparatus 100 associates a thumbnail image with the plurality of images included in the image group. The client apparatus 100 displays a representative thumbnail image for the image group in an image list. In this embodiment, the client apparatus 100 displays a thumbnail image corresponding to an image of a first page of the image group as a representative thumbnail image. A plurality of thumbnail images are displayed in the display unit 205. When a user selects one of the thumbnail images, the client apparatus 100 displays an image or an image group associated with the thumbnail image. When a display target is the image group, the client apparatus 100 successively displays the plurality of images included in the image group in accordance with display order. Hereinafter, portions of the image display system according to the second embodiment which are different from those of the image display system according to the first embodiment will be described.

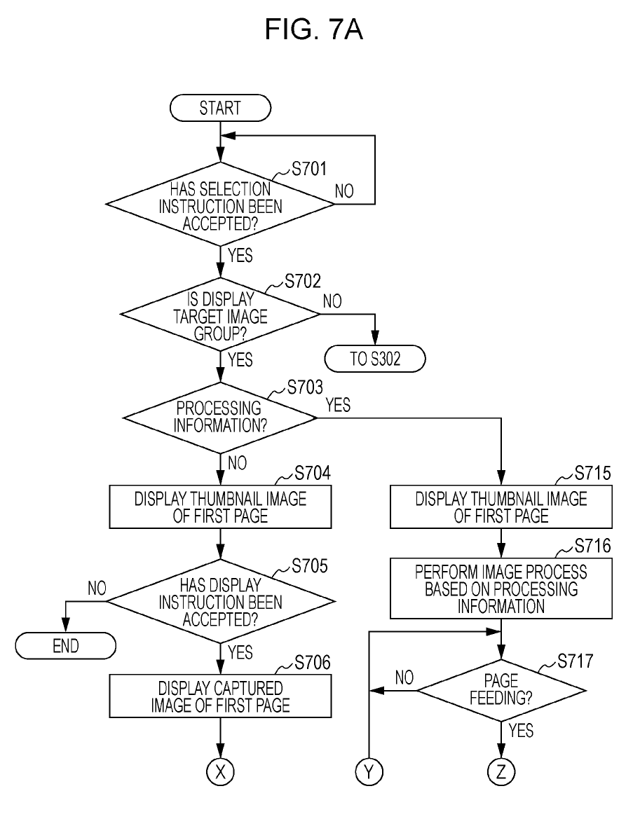

FIGS. 7A, 7B, and 7C are a flowchart illustrating an image display process performed by the client apparatus 100 according to the second embodiment. In step S701, a CPU 201 of the client apparatus 100 waits until the CPU 201 receives a selection instruction. When the CPU 201 receives the selection instruction (Yes in step S701), the process proceeds to step S702. In step S702, the CPU 201 determines whether an image to be displayed in response to the selection instruction is a single image or an image group. When the image to be displayed is an image group (Yes in step S702), the CPU 201 proceeds to step S703. When the image to be displayed is a single image (No in step S702), the CPU 201 proceeds to step S302 and a process in step S302 onwards is performed.

In step S703, the CPU 201 determines whether processing information is associated with the image group to be displayed in a storage device 203. The processing information of the image group is recorded in the storage device 203 in a process in step S710 described below. The processing information of the image group relates to an image process to be performed on captured images included in the image group. Specifically, the processing information of the image group includes information on association between the captured images and the image process to be performed on the captured images. The processing information may include a plurality of pieces of information obtained by associating different image processes with the different captured images. The processing information of the image group also includes information on display order of the plurality of images and the like. When the processing information is not associated with the image group (No in step S703), the CPU 201 proceeds to step S704. When the processing information is associated with the image group (Yes in step S703), the CPU 201 proceeds to step S715.

In step S704, the CPU 201 enlarges a thumbnail image corresponding to a first page of the image group to be displayed so as to display the thumbnail image by pop-up. Specifically, in step S704, since the processing information is not associated with the image group to be displayed, the CPU 201 displays a thumbnail image which has not been subjected to an image process. Subsequently, in step S705, the CPU 201 determines whether an instruction for displaying a captured image corresponding to the thumbnail image has been received. When the CPU 201 receives the display instruction (Yes in step S705), the process proceeds to step S706. When the CPU 201 does not receive the display instruction (No in step S705), the image display process is terminated.

Subsequently, in step S706, the CPU 201 displays the captured image in the first page of the image group to be displayed. Specifically, in step S706, since the processing information is not associated with the image group to be displayed, the CPU 201 displays the captured image which has not been subjected to the image process.

Thereafter, in step S707, the CPU 201 determines whether an instruction for executing an image process on the captured image displayed in a display unit 205 in this process has been received through the input unit 204. When the CPU 201 receives the execution instruction (Yes in step S707), the process proceeds step S708. When the CPU 201 does not receive the execution instruction (No in step S707), the process proceeds step S711. Here, the process in step S707 represents an example of a reception process of receiving an execution instruction.

In step S708, the CPU 201 performs an image process on the captured image being displayed in response to the execution instruction. Next, in step S709, the CPU 201 displays the captured image which has been subjected to the image process, that is, the captured image after the image process, in the display unit 205. In step S710, the CPU 201 stores processing information including content of the image process executed in step S708 and information on association between the captured image being displayed and the thumbnail image in the storage device 203 (processing information management process). Subsequently, in step S711, the CPU 201 determines whether page feeding has been performed. When the page feeding has been performed (Yes in step S711), the CPU 201 proceeds to step S712. When the page feeding has not been performed (No in step S711), the CPU 201 returns to step S707.

In step S712, the CPU 201 determines whether a page being displayed is the last page of the image group. When the page being displayed is the last page (Yes in step S712), the CPU 201 terminates the image display process. When the page being displayed is not the last page (No in step S712), the CPU 201 proceeds to step S713. In step S713, the CPU 201 determines whether a termination instruction has been received. When the CPU 201 receives the termination instruction (Yes in step S713), the image display process is terminated. When the CPU 201 does not receive the termination instruction (No in step S713), the process proceeds step S714.

In step S714, the CPU 201 displays a captured image in the next page, that is, a captured image which has not been subjected to the image process, and thereafter, the process returns to step S707. Here, the captured image in the next page means a captured image which is to be displayed immediately after the captured image displayed in the process in step S706 or the captured image displayed in the process in step S714 which is most recently executed in the display order.

Note that, when different image processes are performed on different pages (different captured images) in the process from step S706 to step S714, processing information including two pieces of information or more corresponding to the image processes is recorded in the storage device 203.

On the other hand, in step S715, the CPU 201 enlarges the thumbnail image of the first page of the image group to be displayed and displays the enlarged thumbnail image by pop-up. Subsequently, in step S716, the CPU 201 performs the image process on the thumbnail image corresponding to the captured image associated with the image process in accordance with the processing information. The CPU 201 further performs the image process on thumbnail images after the thumbnail image associated with the image process to a thumbnail image before a thumbnail image of a predetermined page. It is assumed that the number of predetermined pages is m and a page of the thumbnail image associated with the image process is an X-th page. The CPU 201 performs an image process on thumbnail images in an (X−m)-th page to an (X−1)-th page so that display content is gradually changed from an (X−(m+1))-th page to the X-th page. It is assumed that the number of predetermined pages is set to the storage device 203 in advance, for example.

Here, the image process performed on the thumbnail images in the (X−m)-th page to the (X−1)-th page is the same as the image process performed on the thumbnail image in the X-th page but is different in degree of the processing.

It is assumed that a process of enlarging the thumbnail image of the X-th page Y times is associated with the processing information. In this case, the CPU 201 performs an image process of enlarging the thumbnail image of the (X−m)-th page 1/Y times and an image process of enlarging the thumbnail image of the (X−(m−1))-th page 2/Y times. Similarly, the CPU 201 performs enlargement processes (image processes) in different enlargement factors on the thumbnail images of an (X−(m−2))-th page to the (X−1)-th page so that the images are gradually enlarged to the X-th page. By this, the thumbnail image in the (X−(m+1))-th page which has not been subjected to the image process to the thumbnail image in the X-th page which has been subjected to the image process may be seamlessly displayed.

Note that, when the X-th page is positioned before the m pages, the CPU 201 performs different image processes on the thumbnail images in the second page to the (X−1)-th page so that the images are gradually enlarged to the image in the X-th page.

Next, in step S717, the CPU 201 determines whether page feeding has been performed.

When the page feeding has not been performed (No in step S717), the CPU 201 waits until the page feeding is performed, whereas when the page feeding has been performed (Yes in step S717), the process proceeds to step S718.

In step S718, the CPU 201 determines whether the page being displayed is the last page of the image group. When the page being displayed is the last page (Yes in step S718), the CPU 201 terminates the image display process. When the page being displayed is not the last page (No in step S718), the CPU 201 proceeds to step S719. In step S719, the CPU 201 determines whether a termination instruction has been received. When the CPU 201 receives the termination instruction (Yes in step S719), the image display process is terminated. When the CPU 201 does not receive the termination instruction (No in step S719), the process proceeds step S720.

In step S720, the CPU 201 determines whether a thumbnail image which has been subjected to the image process and which corresponds to the next page exists. Specifically, when the image process is performed on the thumbnail image in the next page in step S716, and therefore, the thumbnail image which has been subjected to the image process exists, the CPU 201 determines that the thumbnail image which has been subjected to the image process exists. When the thumbnail image which has been subjected to the image process exists (Yes in step S720), the CPU 201 proceeds to step S721. When the thumbnail image which has been subjected to the image process does not exist (No in step S720), the CPU 201 proceeds to step S722.

In step S721, the CPU 201 displays the thumbnail image which has been subjected to the image process in the next page and the process returns to step S717. In step S722, the CPU 201 displays the thumbnail image in the next page, that is, the thumbnail image which has not been subjected to the image process, and the process returns to step S717. Here, the process from step S715 to step S721 is an example of a display process of displaying a first image which has not been subjected to an image process and thereafter displaying a second image which is different from the first image which is to be subjected to the image process in a state in which the second image has been subjected to an image process.

In this way, in step S716, the CPU 201 performs the image process on the thumbnail image in the (X−m)-th page to the thumbnail image in the (X−1)-th page so that the images are gradually changed until the thumbnail image which has been subjected to the image process in the X-th page is reached. Then the CPU 201 displays the thumbnail image which has been subjected to the image process in step S721. By this, a plurality of images may be seamlessly displayed from the thumbnail image which has not been subjected to the image process to the thumbnail image which has been subjected to the image process.

Note that, when an image process is associated with the thumbnail image in the first page in the processing information, the CPU 201 performs the image display process according to the first embodiment (refer to FIGS. 3A and 3B). Specifically, the CPU 201 displays a captured image which has been subjected to an image process in the first page after the captured image in the first page which has not been subjected to the image process is displayed for a predetermined period of time.

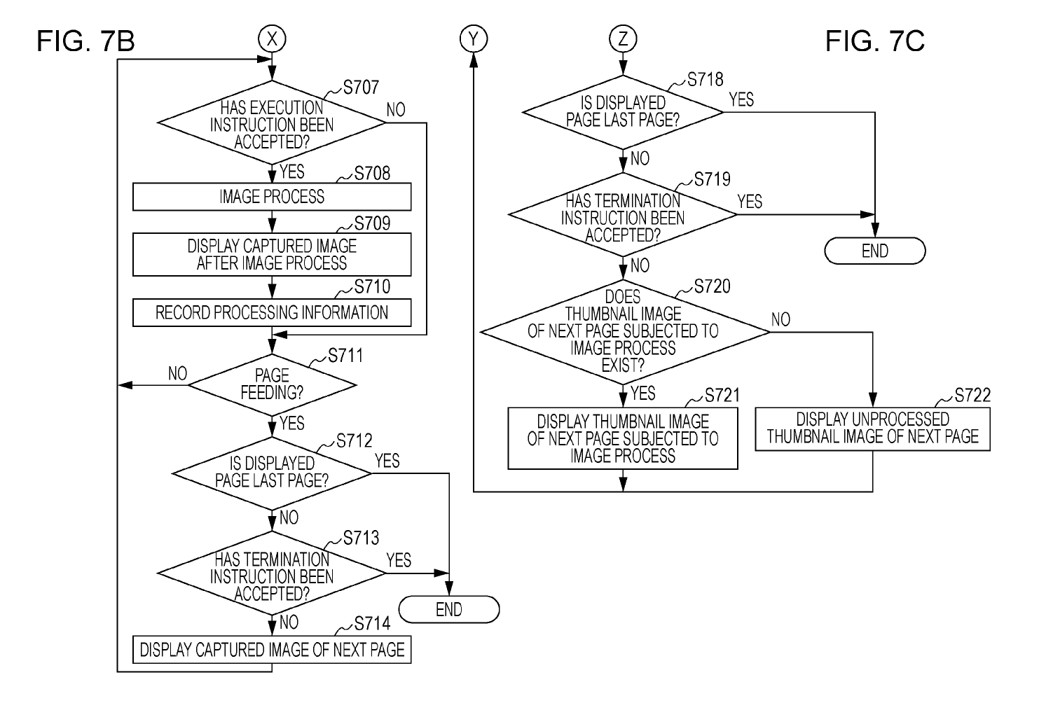

FIG. 8 is a diagram illustrating an image group. An image group 800 includes a plurality of images captured by performing CT or MRI on an upper body of a person A. The image group 800 has an entire width 810 of the person A set as a target of image capturing and includes a plurality of sliced images (captured images) captured in various positions 801 within a range including a heart and a stomach by performing scanning in a direction from a head portion to an abdominal portion. The sliced images included in the image group 800 are displayed in an image-capturing order, and the CPU 201 sequentially displays the sliced images in the direction from the head portion to the abdominal portion in accordance with the page feeding performed in step S711. A doctor as a user checks an affected area or the like while viewing the sliced images which are sequentially displayed. In this embodiment, a case where states of the heart and the stomach are checked will be described as an example.

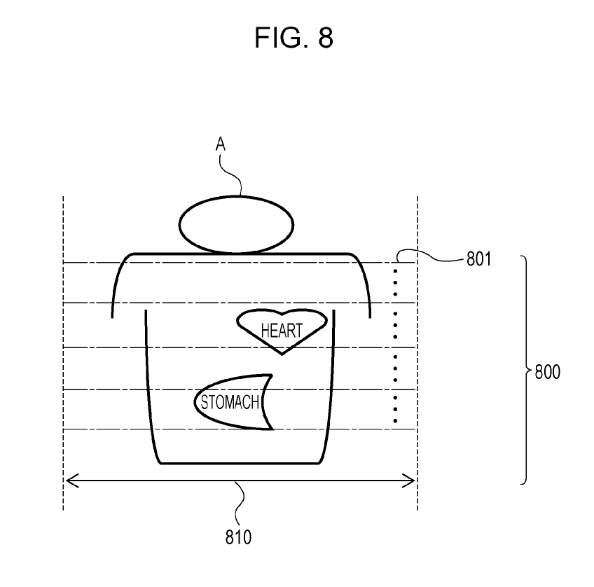

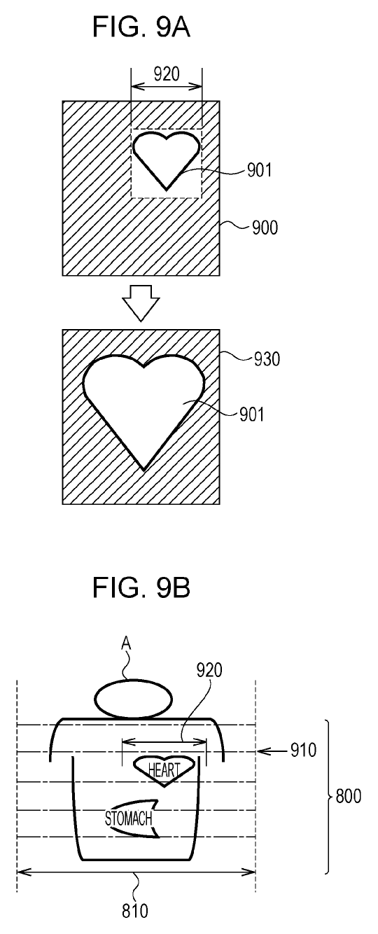

FIGS. 9A and 9B and FIGS. 10A and 10B are diagrams illustrating display of a sliced image. A sliced image 900 of FIG. 9A is an image captured in a position 910 illustrated in FIG. 9B. The sliced image 900 includes an image of a heart 901. It is assumed that, in the sliced image 900, a range 920 including the heart image 901 is selected by the doctor. In this case, the CPU 201 receives an instruction for executing an enlargement process in response to the selection operation performed by the doctor. The CPU 201 performs an image process of displaying the range 920 of the sliced image 900 in an enlargement manner and displays a sliced image 930 obtained after the enlargement process as illustrated in FIG. 9A. By this, the heart image 901 which is a target region is displayed in the enlargement manner.

Thereafter, the sliced images in the next page onwards are displayed in accordance with the display order while the range displayed in an enlargement manner is set as a display range. A sliced image 1000 of FIG. 10A is an image captured in a position 1010 illustrated in FIG. 10B. The sliced image 1000 includes an image 1001 of a stomach.

As illustrated in FIGS. 9A and 9B, when the display range of the sliced image 900 is changed by the doctor, a page of the sliced image is changed while the changed display range is maintained. Specifically, the sliced image 1000 displayed after the sliced image 900 is included in a display range which is the same as that of a sliced image 930 illustrated in FIG. 9B. Therefore, the sliced image 1000 only includes an image of a portion of the stomach.

Therefore, the doctor performs an operation of shifting the display range of the sliced image 1000 to a range 1020 illustrated in FIG. 10B so as to check a state of the stomach. In response to this operation, the CPU 201 receives an instruction for executing the image process of shifting the display range. The CPU 201 performs the image process of shifting the display range of the sliced image 1000 so as to shift the display range from the range 920 to the range 1020 as illustrated in FIG. 10B. By this, a sliced image 1030 including the entire stomach which is a target region is displayed as illustrated in FIG. 10A.

When the image process is executed on a plurality of target regions in this way, the CPU 201 records processing information including information in which the sliced image of the position 910 and the sliced image of the position 1010 are associated with the respective image processes. Note that, although both of the image processes associated with the respective sliced images are enlargement processes, different ranges are enlarged.

On the other hand, when the image group 800 is displayed in accordance with the processing information recorded in response to the process described above, the CPU 201 displays a sliced image of the entire width of the first page, and thereafter, gradually enlarges the images so that the sliced image 930 in the position 910 after the enlargement is displayed. Then the CPU 201 displays sliced images of the entire width following the sliced image in the position 910 in the display order again, and thereafter, gradually enlarges the images so as to display the sliced image 1030 in the position 1010 which has been enlarged.

Note that, as another example, the CPU 201 may display the sliced image 930 in the position 910 which has been enlarged, and thereafter, gradually display the sliced images following the sliced image in the position 910 until the sliced image 1030 in the position 1010 which has been enlarged is reached while a range of a partial region to be displayed in an enlargement manner is gradually shifted.

Note that other configurations and other processes of the image display system according to the second embodiment are the same as those of the first embodiment.

As described above, the image display system according to the second embodiment displays a second image which has been subjected to an image process after displaying a first image which has not been subjected to an image process in a case where an image group including a plurality of images is a display target. Accordingly, the user may check desired information from the displayed image which has been subjected to the image process without performing a complicated operation.

A first modification of the image display system of the second embodiment will be described. It is assumed that different image processes are associated with different images in processing information. In this case, a client apparatus 100 determines a common image process of displaying target regions which are objects to be displayed in the image processes (a determination process). The client apparatus 100 may perform the determined image process on the images associated with the image processes in processing information.

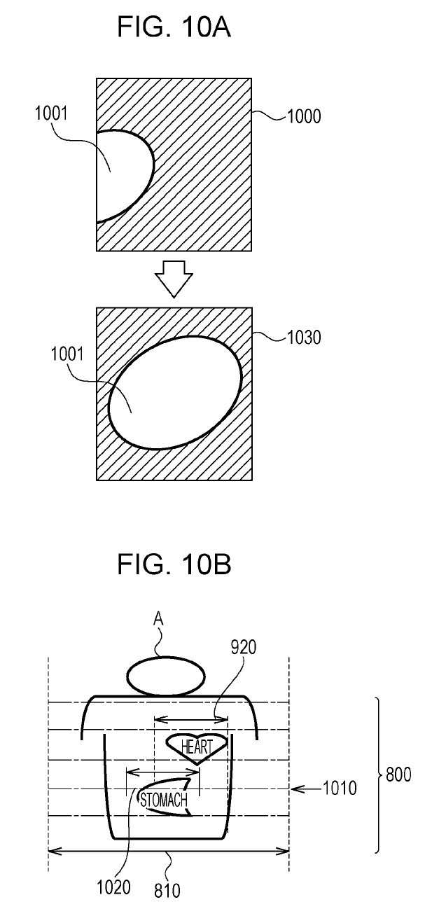

It is assumed that, as illustrated in FIGS. 9A and 9B and FIGS. 10A and 10B, a range 920 including a heart and a range 1020 including a stomach are selected and processing information corresponding to the ranges 920 and 1020 has been stored. In this case, as illustrated in FIG. 11, the client apparatus 100 displays a sliced image of an entire width of a first page, and thereafter, displays the sliced images in the position 910 onwards while a range 1100 including both of the range 920 including the heart and the range 1020 including the stomach is set as a display range. Specifically, in this case, the client apparatus 100 performs the image process not only on images associated with the image process but also on all the images in the position 910 onwards while the range 1100 is set as a display range.

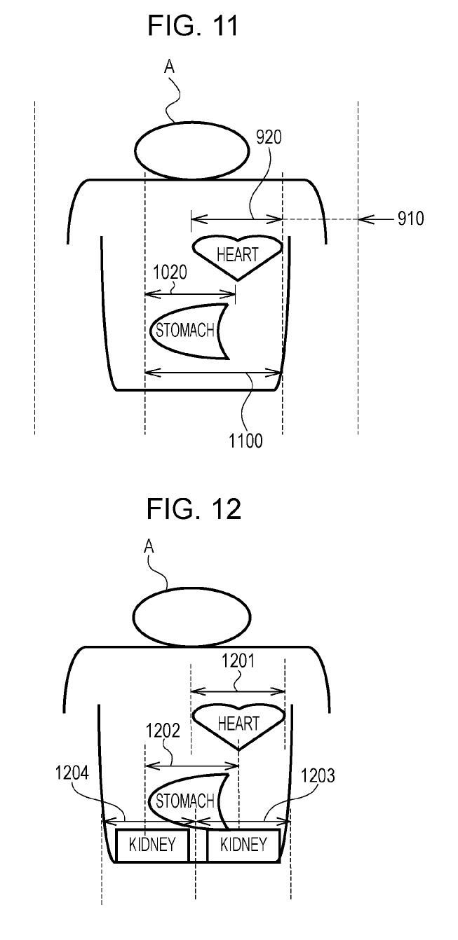

Furthermore, as a second modification, in a case where different image processes are associated with a plurality of images in processing information, an image group may be divided for individual image processes. It is assumed that a heart range 1201, a stomach range 1202, and kidney ranges 1203 and 1204 are individually displayed in an enlargement manner as illustrated in FIG. 12 when a sliced image included in a single image group is displayed. In this case, a client apparatus 100 divides the single image group into four image groups for the target regions displayed in the enlargement manner.

As a third modification, a timing when a client apparatus 100 performs an image process in accordance with processing information is not limited to the embodiments. The client apparatus 100 may perform an image process on a captured image in a page to be displayed every time page feeding is performed.

According to the embodiments described above, a target image may be displayed in an appropriate state without causing a user to perform a complicated operation. Although preferred embodiments of the present invention have been described in detail, the present invention is not limited to the particular embodiments and various modifications and alterations may be made within the scope of the present invention disclosed in claims.

### Other Embodiments

The present invention can take various embodiments such as a system, an apparatus, a method, a program, and a storage medium. Specifically, the present invention is applicable to a system including a plurality of devices and to an apparatus including a single device.

In the foregoing embodiments, at least some of the units illustrated in FIG. 2 (the CPU 201, the communication unit 206, the input unit 204, and the display unit 205) may be realized as independent apparatuses. In that case, the image display system as a whole constitutes the present invention.

Alternatively, at least some of the units illustrated in FIG. 2 may be realized as software including a program that realizes the functions thereof by installing the program into one or more computers and executing the program using a CPU(s) of the computer(s). In that case, the program, a storage medium storing the program, and a computer or a system in which the program is installed constitute the present invention.

Also, the functions of the above embodiments may be realized by executing the read program using the computer. Also, the functions of the embodiments may be realized by cooperation with an operating system or the like running on the computer based on instructions from the program. In that case, the operating system or the like may execute part of or the entirety of the actual processing to realize functions of the above embodiments.

Embodiments of the present invention can also be realized by a computer of a system or apparatus that reads out and executes computer executable instructions recorded on a storage medium (e.g., a non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-093899, filed Apr. 30, 2014, which is hereby incorporated by reference herein in its entirety.

What is claimed is:

1. An image display system comprising:
a display unit configured to display, when processing information representing an image process to be performed on an image to be displayed is associated with the image to be displayed, the image which has been subjected to the image process corresponding to the processing information after the image which has not been subjected to the image process is displayed.

2. The image display system according to claim 1, further comprising:
an image processing unit configured to perform the image process on the image in accordance with the processing information,
wherein the display unit displays the image which has been subjected to the image process performed by the image processing unit.

3. The image display system according to claim 1, further comprising:
a reception unit configured to receive an instruction for selecting a reduced image which is a display target from among a plurality of reduced images displayed as a list,
wherein the display unit displays, when the processing information is associated with the reduced image corresponding to the selection instruction, the reduced image which has been subjected to the image process corresponding to the processing information in an enlargement manner after the reduced image which has not been subjected to the image process is displayed in an enlargement manner.

4. The image display system according to claim 1,
wherein the processing information represents an image process of generating an enlarged image of a portion of the image.

5. The image display system according to claim 1, further comprising:
a first reception unit configured to receive an instruction for executing an image process on the image; and
a processing information management unit configured to record the processing information which represents the image process corresponding to the execution instruction and which is associated with the image in a storage unit,
wherein the display unit displays the image which has been subjected to the image process corresponding to the processing information stored in the storage unit.

6. The image display system according to claim 1,
wherein the display unit displays the image which has not been subjected to the image process, and thereafter, displays the image which has been subjected to the image process after a predetermined period of time has elapsed.

7. The image display system according to claim 1, further comprising:
a second reception unit configured to receive a switching instruction,
wherein the display unit displays the image which has not been subjected to the image process, and thereafter, displays the image which has been subjected to the image process in response to the switching instruction.

8. An image display system comprising:
a display unit configured to display, when processing information representing an image process to be performed on at least one of a plurality of images to be consecutively displayed included in an image group is associated with the image group, a first image included in the image group in a state in which the first image has not been subjected to the image process, and thereafter, display a second image which is different from the first image in a state in which the second image has been subjected to the image process.

9. The image display system according to claim 8, further comprising:
an image processing unit configured to perform the image process on the second image in accordance with the processing information,
wherein the display unit displays the second image which has been subjected to the image process performed by the image processing unit.

10. The image display system according to claim 9,
wherein the image processing unit performs the image process on images between the first image and the second image in a display order so that display content is gradually changed from the first image to the second image which has been subjected to the image process in accordance with the display order of the plurality of images included in the image group, and
the display unit displays the first image, displays the images between the first image and the second image which have been subjected to the image process performed by the image processing unit in the display order, and thereafter, displays the second image which has been subjected to the image process corresponding to the processing information performed by the image processing unit.

11. The image display system according to claim 9,
wherein the image processing unit performs, when the processing information includes information on a first image process to be performed on the second image and a second image process which is different from the first image process and which is to be performed on a third image which is displayed after the second image in the display order, a third image process which is different from the first image process and the second image process on images between the second image and the third image in the display order so that display content is gradually changed from the second image which has been subjected to the first image process to the third image which has been subjected to the second image process, and
the display unit displays the second image which has been subjected to the first image process, sequentially displays the images between the second image and the second image which have been subjected to the third image process performed by the image processing unit in the display order, and thereafter, displays the third image which has been subjected to the second image process.

12. The image display system according to claim 11, further comprising:
a determination unit configured to determine image processes to be performed on the second image and the third image in accordance with the processing information when the processing information includes information on the first image process to be performed on the second image and information on the second image process to be performed on the third image which is displayed after the second image in the display order,
wherein the image processing unit performs the image processes determined by the determination unit on the second image and the third image, and
the display unit displays the second image which has been subjected to the image process performed by the image processing unit before displaying the third image which has been subjected to the image process performed by the image processing unit.

13. The image display system according to claim 8, further comprising:
a division unit configured to divides the image group in a plurality of image groups in accordance with the processing information when the processing information includes information on image processes to be performed on at least two images included in the image group.

14. An image display apparatus comprising:
a display unit configured to display, when processing information representing an image process to be performed on an image to be displayed is associated with the image to be displayed, the image which has been subjected to the image process corresponding to the processing information after the image which has not been subjected to the image process is displayed.

15. An image display apparatus comprising:
a display unit configured to display, when processing information representing an image process to be performed on at least one of a plurality of images to be consecutively displayed included in an image group is associated with the image group, a first image included in the image group in a state in which the first image has not been subjected to the image process, and thereafter, display a second image which is different from the first image in a state in which the second image has been subjected to the image process.

16. An image display method employed in an image display system, the image display method comprising:
a first display step of displaying, when processing information representing an image process to be performed on an image to be displayed is associated with the image to be displayed, the image which has not been subjected to the image process; and
a second display step of displaying the image which has been subjected to the image process corresponding to the processing information after displaying the image which has not been subjected to the image process in the first display step.

17. An image display method employed in an image display system, the image display method comprising:
a first display step of displaying, when processing information representing an image process to be performed on at least one of a plurality of images to be consecutively displayed included in an image group is associated with the image group, a first image included in the image group in a state in which the first image has not been subjected to the image process; and
a second display step of displaying a second image which is different from the first image to be subjected to the image process in a state in which the second image has been subjected to the image process after the first image is displayed in the first display step.

18. An image display method employed in an image display apparatus, the image display method comprising:
a first display step of displaying, when processing information representing an image process to be performed on an image to be displayed is associated with the image to be displayed, the image which has not been subjected to the image process; and
a second display step of displaying the image which has been subjected to the image process corresponding to the processing information after displaying the image which has not been subjected to the image process in the first display step.

19. An image display method employed in an image display apparatus, the image display method comprising:
a first display step of displaying, when processing information representing an image process to be performed on at least one of a plurality of images to be consecutively displayed included in an image group is associated with the image group, a first image included in the image group in a state in which the first image has not been subjected to the image process; and
a second display step of displaying a second image which is different from the first image to be subjected to the image process in a state in which the second image has been subjected to the image process after the first image is displayed in the first display step.

20. A memory which stores a program which causes a computer to function as a display unit configured to display, when processing information representing an image process to be performed on an image to be displayed is associated with the image to be displayed, the image which has been subjected to the image process corresponding to the processing information after the image which has not been subjected to the image process is displayed.

21. A memory which stores a program which causes a computer to function as a display unit configured to display, when processing information representing an image process to be performed on at least one of a plurality of images to be consecutively displayed included in an image group is associated with the image group, a first image included in the image group in a state in which the first image has not been subjected to the image process, and thereafter, display a second image which is different from the first image in a state in which the second image has been subjected to the image process.
